(19) United States
(12) Patent Application Publication
(10) Pub. No.: US 2026/0361437 A1
(43) Pub. Date: Nov. 12, 2026

(54) SYSTEMS AND METHODS FOR USING ARTIFICIAL INTELLIGENCE TO COORDINATE THE DEPLOYMENT OF SUPPLEMENTAL COVERAGE FROM SPACE RESOURCES

(71) Applicant: AALYRIA TECHNOLOGIES, INC., LIVERMORE, CA (US)

(72) Inventors: STEFAN DRASKOCI, LONDON (GB); BRIAN BARRITT, PITTSBURGH, PA (US); LUCA LODIGIANI, LONDON (GB)

(21) Appl. No.: 19/666,222

(22) Filed: May 2, 2026

Related U.S. Application Data
(60) Provisional application No. 63/801,286, filed on May 7, 2025.
(60) Provisional application No. 63/886,564, filed on Sep. 23, 2025.

(51) Int. Cl. H04B 17/391; H04B 17/318; H04L 41/14

(52) U.S. Cl. CPC H04B 17/3913; H04B 17/318; H04L 41/145

(57) ABSTRACT

The current disclosure utilizes data collection and interference power threshold determination capabilities in a telecommunications network to enable the deployment of Supplemental Coverage from Space resources to allow for network coverage while mitigating interference between terrestrial network (TN) and non-terrestrial network (NTN) resources.

### CROSS REFERENCE TO RELATED APPLICATIONS

This U.S. Non-Provisional Application claims the benefit of priority U.S. Provisional Application Number 63/886,564, filed Sep. 23, 2025; and also claims the benefit of priority U.S. Provisional Application Number 63/801,286, filed May 7, 2025, the disclosures of which are incorporated by reference herein in their entirety.

### BACKGROUND

Mobile telecommunication networks may provide wireless connectivity that may enable voice, data, and/or internet services for mobile devices across wide geographic areas. Terrestrial networks may provide the ground-based infrastructure (e.g., cell towers, antennas, and/or fiber links) that may enable mobile devices to connect to the broader telecommunications system. Gaps in connectivity may exist where the deployment of terrestrial base stations has proven to be physically infeasible or commercially unavailable. Proprietary satellite systems may be utilized to serve such remote regions, however these have in most cases proven to be too inaccessible and impractical to the end user to see widespread adoption.

The 3GPP family of standards for mobile networks has achieved global adoption and usage and has given rise to billions of mobile devices which support a number of generations of the standard (3G, 4G, 5G, etc.). The combination of these standards with the ubiquitous reach of satellites presents a compelling solution to deliver connectivity to unconnected regions and people.

This opportunity was recognized in 3GPP and has been actively addressed in recent years as a new flavor of the 5G new radio (NR) standard, called 5G Non-Terrestrial Networks (NTN). Non-Terrestrial Networks may utilize spaceborne (e.g., satellites), airborne (e.g., drones or balloons), or other non-ground-based platforms to act as a repeater of a 5G waveform which may be generated on the ground. In an example, Low Earth Orbit satellite constellations may be the preferred mode of delivery (e.g., via earth-fixed cells or satellite-fixed cells). In this example, a 5G next generation Node B (gNodeB or gNB) Radio Access Network (RAN) stack may generate a downlink (DL) NR-Uu waveform that may be transmitted by a NTN gateway to the LEO satellite(s) via a feeder link, where the NR-Uu waveform may be repeated, typically on another frequency, and retransmitted down to a terrestrial mobile device, a user equipment (UE), on a service link. In contrast, an uplink NR-Uu waveform may follow a reverse path, being transmitted by the UE via the service link to the LEO satellite(s), where the signal is retransmitted via the feeder link down to the NTN gateway and 5G gNodeB RAN.

In some examples, RAN components may be proprietary or tightly integrated by a single vendor. In other examples, such as an Open Radio Access Network (O-RAN), the RAN may be split into modular components that may come from different vendors. The O-RAN may include a radio unit to handle radio frequency transmissions and reception. A Service Management and Orchestration (SMO) may be a component in the O-RAN architecture responsible for managing or orchestrating the lifecycle of RAN components (e.g., gNBs, RIC Applications (rApp), or extensible applications (xApp)); provisioning, monitoring, or optimizing network functions; hosting rApps; or interfacing with operations support systems or other management systems. In some examples, xApps may include near-real-time applications. The O-RAN may further include a distributed unit to process real-time data like scheduling or beamforming. The O-RAN may further include a central unit and RAN Intelligent Controller (RIC). In some examples, the RIC may include a Near-Real-Time (RT) RIC and/or a Non-RT RIC. In these examples, the Near-RT RIC may enable real-time control. The non-RT RIC may enable long-term optimization or policy management. The use of open interfaces may enable the equipment from different vendors to work together. An RIC Application (rApp) may run on the Non-RT RIC to enable policy management, machine learning model training, network optimization, long term analytics or other functions.

Subsequent releases of 3GPP may tackle the complexities of hosting a 5G gNodeB onboard satellites and having the capability to route traffic flows over Inter-Satellite Links (ISLs) to other satellites. These kinds of networks may offer greater flexibility to the end-to-end delivery of connectivity, but in doing so they may also increase operational complexity. Over time, Direct-to-Device 5G NTN services will evolve towards being capable of delivering higher data rates to the UE(s) to support different services.

The market is trending towards 5G NTN constellations being owned and operated by incumbent and emerging Satellite Network Operators (SNOs), who are distinct to the terrestrial Mobile Network Operators (MNOs) whose coverage gaps they are filling. Supplemental Coverage from Space (SCS) may provide an example in which SNO coverage may fill coverage gaps in the MNO coverage. Each independent 5G NTN constellation is intended to act as a logical extension of a number of 5G terrestrial networks all over the world, where the mobile devices are expected to roam onto the former in the absence of the latter. The end goal is to enable mobile users to consume connectivity services with minimal impact on their perceived experience, including seamless transitions/handovers between 5G Terrestrial Networks (TNs) and 5G NTNs. A key challenge in achieving this end goal is that the current 3GPP standards do not sufficiently address the architectural implementations and processes by which 5G TNs and NTNs will integrate and coordinate at the RAN and Core levels, to allow mobile devices (UEs) to be seamlessly handed over from one to the other.

Terrestrial network coverage gaps are in some cases quite wide, while in other cases significantly smaller. A UE driving on a highway might leave, re-enter, and again leave the terrestrial coverage area every couple of minutes. In order to assure seamless consumption of connectivity services, the network should be capable of maintaining voice and data-based conversations (e.g., WhatsApp) during the handovers between the TN and the NTN. In handover events between terrestrial base stations, this is achieved either by having an interface between the two gNodeBs which allows them to coordinate (e.g., the Xn interface), or by having them do so via their common Core Network (e.g., via the Next Generation (NG) interface). The establishment of this kind of interfacing on a global scale between the SNOs and various MNOs would be very difficult to achieve. As such, another key challenge is that current 3GPP standards for 5G NTN account for traditional mobile roaming between operators as being the handover procedure for transitions between the two, which would pose a significant interruption for a user to their consumption of connectivity services.

There are new NTN control plane signaling measures that were introduced by 3GPP to aid UEs for the initial access and mobility procedures, such as the System Information Block 19 (SIB19). These are intended to be unicast or broadcast by the TN RAN to UEs which are soon to be connected to the NTN network. The UEs use this information about their target satellite to properly synchronize in time and frequency with the NTN segment, to facilitate TN-to-NTN handover. In integrated TN and NTN environments, maintaining seamless coverage is challenged by dynamic conditions that may introduce or exacerbate coverage gaps within or between the two domains. Factors such as atmospheric interference, terrain obstructions, and satellite beam transitions can disrupt connectivity. These disruptions may necessitate mechanisms for proactive planning and real-time awareness to ensure continuity in network coverage. These mechanisms may include systems or methods to anticipate, detect, or respond to coverage gaps between TN and NTN, including SCS, to maintain reliable communication across diverse contexts.

A real-time determination of telecommunications network (e.g., TN or NTN) capabilities may be necessary for a plurality of reasons. In an example, an emergency may detrimentally impact the ability of a network to provide coverage to UEs in the network's coverage area. A lack of network coverage in an area may negatively affect emergency response coordination, public safety, infrastructure assessment, business continuity, data integrity and security, or community support.

### SUMMARY

The current disclosure utilizes data collection and interference power threshold determination capabilities in a telecommunications network to enable the deployment of SCS resources to allow for network coverage while mitigating interference between TN and NTN resources.

In an aspect of the present disclosure, a method may be provided for coordinating the deployment of SCS resources. The method may include steps of: (A) detecting using a NTN controller, a mixed network of one or more space array antennas, one or more user equipment radio characteristic, one or more satellite channel models, and one or more terrain model and radio propagation; (B) modeling, using the NTN controller, the mixed network; (C) generating, using the NTN controller, a prediction model of signal power in one or more areas, which may be defined by geographical proximity to one or more terrestrial cells; (D) recording data from an NEN, including signal levels from one or more user equipment and network measurements on serving networks and non-serving networks, including metrics and configurations, to assess and optimize network performance; (E) receiving, using the NTN controller, signal level measurements detected by a mobile network operator via one or more inter-domain application program interfaces; (F) synthesizing the signal level measurement information; (G) analyzing, using the NTN controller, the synthesized signal level measurement information; (H) refining the prediction model, using the NTN controller that implements a machine learning model trained on signal level data from one or more user equipment.

### DESCRIPTION OF THE DRAWINGS

FIG. 1 is a diagram of an example telecommunication network in accordance with an example of the present disclosure.

FIG. 2A is a diagram of example NTN controllers deploying SCS resources to provide network coverage in coordination with terrestrial networks in accordance with an example of the present disclosure.

FIG. 2B is a diagram of example NTN controllers deploying SCS resources to provide network coverage in coordination with terrestrial networks in accordance with an example of the present disclosure.

The details above in the Brief Description of the Drawings are intended to describe only some aspects relating to certain embodiments of the innovations herein and should not be deemed in any way limiting with respect to requiring or omitting any aspect for embodiments to be claimed or otherwise limiting the disclosure or embodiments keeping with its scope or spirit.

### DETAILED DESCRIPTION

Static telecommunications network coverage planning may include an initial, fixed design of a telecommunication network's coverage area. This initial plan may simplify deployment of the network and interference management. Interference management may refer to strategies and/or techniques that may be used to minimize or mitigate negative effects of radio signal interference between different transmitters and/or receivers. Although the static coverage plan may simplify this planning, it is not optimal for managing deployment and other interference that may arise. In instances where TN cells and SCS cells may be adjacent to each other, buffer zones or isolation zones may be placed on the edges of the TN cells and/or SCS cells to reduce the impact of co-channel interference due to frequency reuse from space. Factors, such as topology of the surrounding environment may impact coverage and interference management. However, lack of awareness on the actual signal environment may lead to insufficient information available for network coverage planning and/or management. Creating large isolation zones may mitigate the lack of information, however, the existence of large isolation zones may reduce the effectiveness of SCS deployment, create large service gaps, or may require complex manual cell re-planning. The complexity of planning and management of network coverage may exist for interference management between NTN cells (e.g., intra-satellite and/or inter-satellite). The present disclosure may utilize NTN resources to model a telecommunications network that may include TN and NTN resources to develop and/or execute a network coverage plan that may integrate NTN and TN resources.

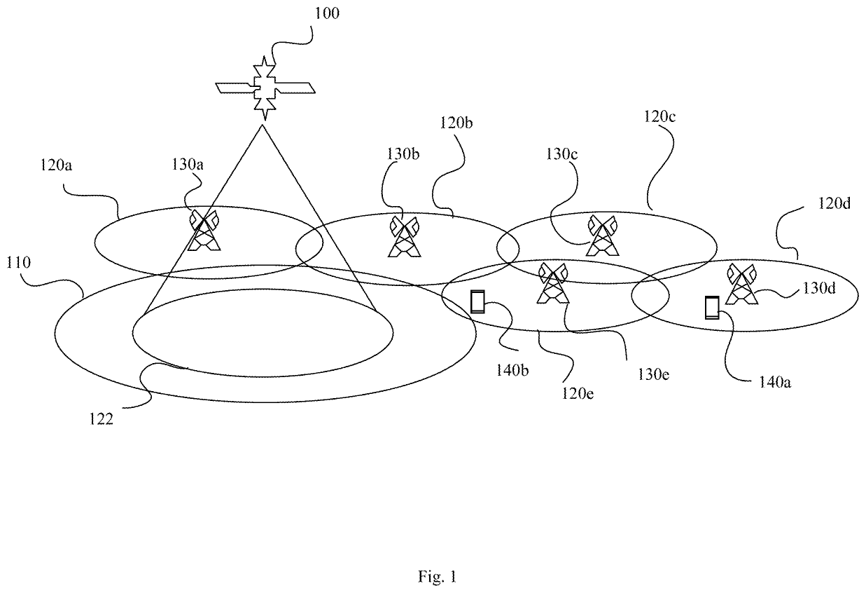

FIG. 1 illustrates an example telecommunications network in accordance with an example of the present disclosure. As illustrated in FIG. 1, a telecommunications network may include one or more network cell(s) (e.g., network cells 120a-120e). In some examples, network cell(s) 120a-120e include one or more geographic areas that may be served by a TN or NTN. As illustrated in FIG. 1, the TN may include base stations 130a-130e. At FIG. 1, base stations 130a-130e may include ground-based infrastructure that may facilitate wireless communication between one or more user devices (e.g., UE 140a and/or UE 140b) and a core network to which all of the devices are connected. In some examples, base station(s) 130a-130e may include space array antennas. In some examples, a base station may cover a single network cell. For example, base station 130a may cover network cell 120a. In other examples, a base station may cover multiple network cells. For example, base station 130a may cover network cell, network cell 120b, and network cell 120c. In some examples, base stations 130a-130e may include radio equipment, antennas, power supplies, and/or backhaul connections. At FIG. 1, UE 140a and/or UE 140b may include consumer devices (e.g., smartphones, tablets, laptops, and/or wearables), fixed wireless devices (e.g., home routers and/or satellite terminals), Internet of Things (IoT) or Machine-to-Machine (M2M) devices (e.g., smart meters, connected vehicles, industrial sensors, and/or asset trackers), industrial equipment (e.g., ruggedized handhelds, private network terminals, and/or mission-critical communication devices), and/or specialized equipment (e.g., drones with cellular or satellite connectivity, augmented or virtual reality headsets, and/or medical devices with telemetry features).

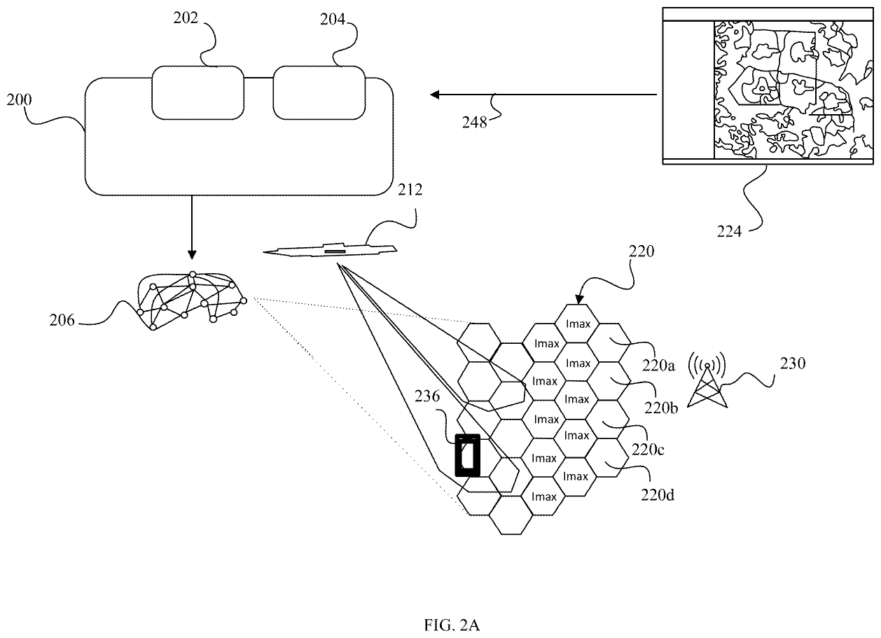

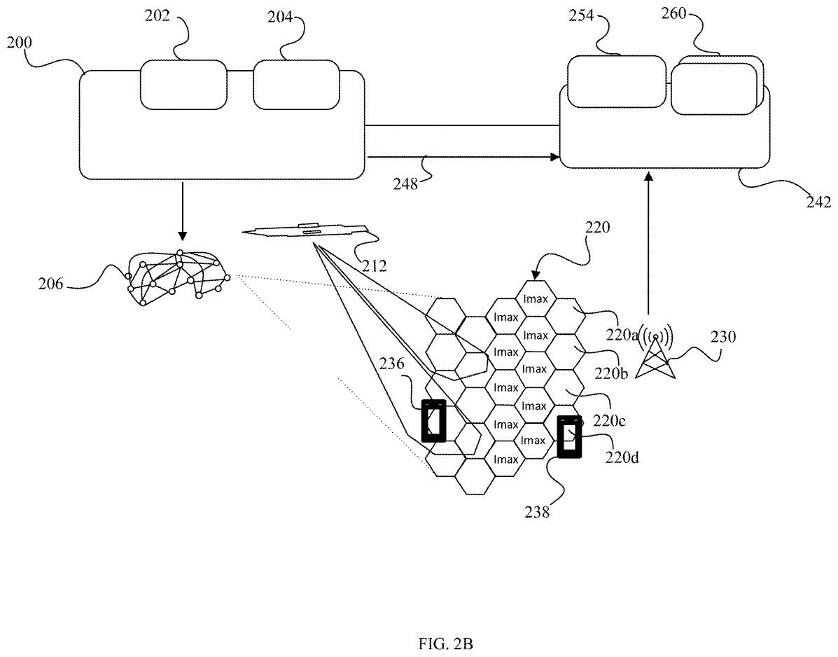

As illustrated in FIG. 1, the NTN may include one or more platform 100. In some examples, platform 100 may cover a single network cell. For example, platform 100 may cover network cell 120a. In other examples, platform 100 may cover multiple network cells. For example, platform 100 may cover network cell 120d and network cell 120e. In some examples, the one or more platform(s) 100 may be a part of an SCS network which may include one or more satellite components. For example, the one or more platform(s) 100 may include a LEO satellite. In other examples, the one or more platform(s) 100 may include airborne components. For example, the one or more platform(s) 100 may include one or more unmanned aerial vehicles (UAVs). It should be recognized that the one or more platform(s) 100 may include one or more satellite components and one or more airborne components. In some examples the NTN may include a controller (e.g., Non-RT RIC, Near-RT RIC, or controller 200 as displayed in FIGS. 2A and 2B). As illustrated in FIG. 1, base station 130d covers network cell 120d, thereby facilitating wireless communication coverage for UE 140a. As illustrated in FIG. 1, the network coverage may leave white spot 122. At FIG. 1, white spot 122 may be a geographic area that may present a coverage gap within or between network cells 120a-120e. In some examples, white spot 122 may be caused by geographic obstacles. For example, mountains may block coverage from base stations 130a-130e to white spot 122. In other examples, white spot 122 may be caused by infrastructure limitations. For example, outdated or insufficient base stations may not be able to provide coverage to white spot 122. As illustrated in FIG. 1, one or more platform(s) 100 may be deployed to provide coverage for white spot 122. In this way, the NTN may provide network coverage for a geographic area that that may not be covered by the TN. In some examples, when providing coverage for white spot 122 by platform(s) 100, zone 110 may be placed at the edges of white spot 122 to mitigate interference between a base station (e.g., base station 130a, base station 130b, or base station 130e) and platform(s) 100.

FIGS. 2A and 2B illustrate example NTN controllers deploying SCS resources to provide coverage in coordination with terrestrial networks in accordance with an example of the present disclosure. As illustrated in FIGS. 2A and 2B, one or more network cell(s) 220a-220d may be grouped together to form mosaic 220. It should be recognized that mosaic 220 may include any number of network cells (e.g., network cell(s) 220a-220d). For example, mosaic 220 may include four network cells (e.g., network cell(s) 220a-220d). For another example, mosaic 220 may include 25 network cells. Network cells 220 a-220d may be referred to interchangeably herein. It should further be recognized that network cells 220a-220d may represent any network cell depicted in FIGS. 2A and 2B, including the unlabeled network cells. As illustrated in FIGS. 2A and 2B mosaic 220 may be covered by base station 230 or platform 212, enabling signal availability and connectivity for UE 236 and/or UE 238 in network cell 220a, network cell 220b, network cell 220c, and/or network cell 220d. UE 236 and UE 238 may be used interchangeably herein. In some examples, base station 230 may be a part of a TN that is owned or controlled by an MNO (e.g., MNO 242 from FIG. 2A). For example, the TN may include one or more base station(s) 230, remote radio heads (RRHs), distributed antenna systems (DAS), backhaul and fronthaul links, and/or power supply and cooling systems. It should be recognized that base station 230 may represent any number base stations that may provide network coverage for mosaic 220. For example, base station 230 may include one base station providing coverage for all network cells in mosaic 220. For another example, base station 230 may include 25 base stations, with each providing network coverage for one network cell in mosaic 220. At FIGS. 2A and 2B, platform 212 may share the same attribute set as platform(s) 100 as described herein. In some examples, platform 212 may be a part of an NTN.

At FIGS. 2A and 2B, controller 200 may include an SMO framework that may be capable of managing TN and NTN, including those that may be operated by SNOs. In some examples, controller 200 may be configured to perform one or more functions of a Non-RT RIC and/or a Near-RT RIC. In some examples, controller 200 may be utilized to coordinate the deployment of platform 212. At FIGS. 2A and 2B, controller 200 may include a solver configured to optimize an NTN, process inputs from a network, and/or support rApps and/or xApps. In some examples, the solver may be part of an artificial intelligence (AI) decision-making loop. AI, machine learning (ML) model, large language model (LLM), and neural network (NN) may be used interchangeably herein. For example, the solver may use ML models trained on historical and/or simulated NTN data. For another example, the solver may run optimization algorithms. At FIGS. 2A and 2B, controller 200 may support application 202 and application 204. In some examples, application 204 may include xApps and/or rApps for network coverage management. In some examples, application 202 may include NTN xApps and/or rApps. For example, application 202 may include SCS rApps.

At FIGS. 2A and 2B, controller 200 may detect a mixed network that may include one or more base station(s) 130a-130e, one or more UE(s) 140a-140b, one or more platform(s) 212, one or more satellite channel models, mosaic 220, and/or one or more terrain models and/or radio propagation. In some examples, the one or more base station(s) 130a-130e may include one or more space array antennas. In some examples, a satellite channel model may include a mathematical or simulation-based representation of how signals may propagate between a satellite and a ground station. In this way a satellite channel model may capture physical and environmental effects that may impact a signal as it travels through space and the Earth's atmosphere. At FIGS. 2A and 2B, controller 200 may generate model 206 of the mixed network. In this way, controller 200 may have an internal representation of network resources which may be used for planning or real-time adjustments while providing connectivity. In some examples, model 206 may be an internal topology model. As illustrated in FIGS. 2A and 2B, model 206 may be a prediction model of signal power in one or more areas (e.g., network cell 220a-220d). In some examples, the one or more areas in model 206 may be defined by geographical proximity to network cell 220a-220d. In some examples, controller 200 may generate an initial interference threshold map. At FIGS. 2A and 2B, controller 200 may overlay the prediction model of signal power in model 206. At FIGS. 2A and 2B, the initial interference threshold map in model 206 via a northbound interface (NBI). In some examples, the NBI may serve as a conduit to enable controller 200 to aggregate the interference threshold map with one or more network management and orchestration systems. For example, controller 200 may aggregate the interference threshold map with an MNO. For another example, controller 200 may aggregate the interference threshold map with an SNO.

As illustrated in FIGS. 2A and 2B, as controller 200 utilizes platform 212 to provide network coverage to one or more network cell(s) 220a, controller 200 may perform beam shaping to optimize coverage for network cell(s) 220a in order to provide connectivity for one or more UE(s) 236. For example, controller 200 may utilize platform 212 to use a narrow, high-gain beam to provide coverage for network cell 220a located in an urban area, due to high user density. In some examples, controller 200 may adjust resource allocation and/or downlink power control to maintain power flux density (PFD) below an interference power threshold in the network cell(s) 220a that may be adjacent to one or more network cell(s) 220b that may be covered by a base station 230 (e.g., the TN). For example, if platform 212 (e.g., the SCS) covers network cell 220a and a base station 230 (e.g., the TN) covers network cell 220b, controller 200 may allocate resources and downlink power to maintain PFD below the interference power threshold in network cell 220a.

At FIGS. 2A and 2B, controller 206 may record data including signal levels from UE 236 and/or network measurements on a serving network and/or a non-serving network. In some examples, the network measurements may include 5G NR network measurements and performance monitoring. For example, the network measurements may include a synchronization signal block measurement timing configuration (SMTC), a zero-power channel state information reference signal (ZP-CSI-RS), channel state information—interference measurement (CSI-IM), and/or minimization of drive test (MDT) reports. In some examples, controller 200 may monitor the non-serving network to assess it for handover decisions. In some examples, controller 200 may utilize a non-serving network for emergency services. At FIGS. 2A and 2B, controller 200 may synthesize the signal level measurement information. Controller 200 may analyze the synthesized signal level measurement information to refine model 206.

At FIG. 2A, an MNO (e.g., MNO 242) may detect signal information from one or more network cell(s) 220a that may be covered by base station 230 and/or controlled by the MNO. In some examples, the MNO may generate database 224 of interference power thresholds over the base station 230 coverage edge (e.g., one or more network cell(s) 220a-220d, or all or part of mosaic 220) as an output of network cell planning. At FIG. 2A, database 224 may be a graphical display of interference power thresholds overlayed on the TN coverage area. In some examples, the base station 230 coverage edge may refer to the limit of where network cell(s) 220a-220d may provide a usable signal. In other examples, the base station 230 coverage edge may refer to the outermost boundary of mosaic 220. At FIG. 2A, the MNO may share the network cell(s) 220a signal information and/or list of interference power thresholds with controller 200. In some examples, the MNO may detect one or more white spots (e.g., white spot 122 from FIG. 1). For example, the one or more white spots may represent one or more coverage gaps within or between network cell(s) 220a-220d and/or within mosaic 220. At FIG. 2A, the MNO may share the one or more white spots with controller 200.

As illustrated in FIG. 2B, UE 236 and/or UE 238 may utilize a telecommunications network that may be covered by platform 212 and/or base station 230. At FIG. 2B, base station 230 may be controlled by MNO 242 as part of a TN while platform 212 may be controlled by controller 200 as part of an NTN. In some examples, MNO 242 may own or control the TN. As illustrated in FIG. 2B, interface 248 may include an application programming interface that may enable communication or interoperability between controller 200 and MNO 242. In some examples, controller 200 and MNO 242 may communicate to enable the coordination of the NTN and TN to provide coverage for user devices as they move between network cells. For example, interface 248 may enable roaming of UE 236 between coverage from platform 212 (e.g., the NTN) and base station 230. At FIG. 2B, MNO 242 may record signal levels from network cell(s) 220a that may be serving UE 236 or UE 238 and/or measurements from their neighbor cell(s) 220a-220d. In some examples, the measurements may be reported to MNO 242 by base station(s) 230. In other examples, MNO 242 may include a self-organizing network (SON) that may be utilized by MNO 242 to automatically configure new base station(s) 230 that may be added to the network, continuously adjust parameters (e.g., power levels or handover thresholds) to improve network performance, and/or detect and compensate for network faults or outages. For example, MNO 242 may utilize the SNO to optimize handover between the base station(s) 230 and platform 212. At FIG. 2B, measurements from UE 236, UE 238, and/or network cell(s) 220a may be reported to the SON.

As illustrated in FIG. 2B, MNO 242 may include a network management system (e.g., non-RT RIC) that may include application 254 and application 260 that may run within the network management system. In some examples, application 254 may include a broker application that may facilitate communication, coordination, and/or data exchange between different applications or systems (e.g., rApps, xApps, and/or RICs). In some examples, application 260 may include one or more rApps and/or xApps that may run on the TN. At FIG. 2B, MNO 242 may calculate the interference power threshold values over the TN coverage edge. In some examples, MNO 242 may utilize the SON to calculate the interference power threshold values. In other examples, MNO 242 may utilize an SMO and/or Non-RT RIC layer to calculate the interference power threshold values. In other examples, MNO 242 may utilize application 260 to calculate the interference power threshold values.

At FIG. 2B, application 254 may aggregate data from MNO 242, compute feedback information that may be used to update model 206, and/or advertise to interface 248 that the feedback information may exist. At FIG. 2B, MNO 242 shares the interference pawer threshold values to controller 200. In some examples, MNO 242 may share interference values for each network cell (e.g., network cell 220a, network cell 220b, network cell 220c, and/or network cell 220d). In other examples, MNO 242 may present an average interference power threshold value across all network cell(s) 220a in mosaic 220. At FIG. 2B, controller 200 may share PFD values (e.g., as adjusted in FIG. 2A) for the areas (e.g., network cell(s) 220a) that may exist at boundaries of the TN and NTN to MNO 242 via interface 248. For example, if network cell 220a is covered by base station 230, and network cell 220b is covered by platform 212, the boundary between network cell 220a and network cell 220b may be a boundary between the TN and NTN. In this example, controller 200 may share the PFD values of network cell 220a and/or network cell 220b to MNO 242 via interface 248.

In an embodiment, a method for coordinating the deployment of Supplemental Coverage from Space (SCS) resources, may comprise: detecting, using a nonterrestrial network controller, a mixed network, wherein the mixed network comprises one or more space array antennas, one or more user equipment radio characteristics, one or more satellite channel models, and one or more terrain models and radio propagation; modeling, using the nonterrestrial network controller, the mixed network; generating, using the nonterrestrial network controller, a prediction model of signal power in one or more areas; recording, using the nonterrestrial network controller, data comprising signal levels from one or more user equipment (UE) and network measurements on serving networks and non-serving networks; receiving, using the nonterrestrial network controller, signal level measurements detected from a mobile network operator via one or more inter-domain application program interfaces; synthesizing the signal level measurement information; analyzing the synthesized signal level information; and refining the model, using the nonterrestrial network controller that implements a machine learning model trained on the signal level data from the one or more UE.

In the embodiment, wherein the one or more areas are defined by geographical proximity to one or more terrestrial cells.

In the embodiment, wherein the network measurements comprise metrics and configurations to assess and optimize network performance.

In the embodiment, wherein the signal data network measurements are recorded from network cells that are within the NTN.

1. A method for coordinating the deployment of Supplemental Coverage from Space (SCS) resources, the method comprising:
detecting, using a nonterrestrial network controller, a mixed network, wherein the mixed network comprises one or more space array antennas, one or more user equipment radio characteristics, one or more satellite channel models, and one or more terrain models and radio propagation;
modeling, using the nonterrestrial network controller, the mixed network;
generating, using the nonterrestrial network controller, a prediction model of signal power in one or more areas;
recording, using the nonterrestrial network controller, data comprising signal levels from one or more user equipment (UE) and network measurements on serving networks and non-serving networks;
receiving, using the nonterrestrial network controller, signal level measurements detected from a mobile network operator via one or more inter-domain application program interfaces;
synthesizing the signal level measurement information;
analyzing the synthesized signal level information; and
refining the model, using the nonterrestrial network controller that implements a solver trained on the signal level data from the one or more UE.

2. The method of claim 1, wherein the one or more areas are defined by geographical proximity to one or more terrestrial cells.

3. The method of claim 1, wherein the network measurements comprise metrics and configurations to assess and optimize network performance.

4. The method of claim 1, wherein the signal data network measurements are recorded from network cells that are within the NTN.

5. The method of claim 1, further comprising generating, using the nonterrestrial network controller, an initial interference threshold map and overlaying the prediction model with the initial interference threshold map via a northbound interface (NBI).

6. The method of claim 5, wherein the NBI serves as a conduit to enable the nonterrestrial network controller to aggregate the interference threshold map with one or more network management and orchestration systems.

7. The model of claim 6, wherein the nonterrestrial network controller aggregates the interference threshold map with a mobile network operator.

8. The model of claim 6, wherein the nonterrestrial network controller aggregates the interference threshold map with a satellite network operator.

9. The method of claim 1, wherein the solver is configured to one or more of optimize the mixed network, process inputs from the mixed network, and support extensible applications.

10. The method of claim 1, wherein the solver is one or more of an artificial intelligence decision-making loop, a machine learning model, a large language model, and a neural network.

11. The method of claim 1, wherein the solver may use the machine learning model further trained on one or more of historical and simulated mixed network data.
